(19) United States
(12) Patent Application Publication
(10) Pub. No.: US 2004/0247812 A1
(43) Pub. Date: Dec. 9, 2004

(54) Process for making labels having non-adhesive portion

(75) Inventors: Andrew B. Milliorn, Kennedale, TX (US); J. Michael Milliorn, Fort Worth, TX (US)

Correspondence Address: ECOLAB INC., 840 SIBLEY MEMORIAL HIGHWAY, MENDOTA HEIGHTS, MN, 55118, US

(73) Assignee: Daydots Holdings, Inc., Fort Worth, TX (US)

(21) Appl. No.: 10/799,430

(22) Filed: Mar. 12, 2004

Related U.S. Application Data
(62) Division of application No. 09/938,920, filed on Aug. 24, 2001.

(51) Int. Cl. G09F 3/10; G09F 3/02; B32B 31/18; B32B 33/00; B65C 9/46

(52) U.S. Cl. 428/41.8; 428/40.1; 156/277; 156/289; 156/267; 156/268; 283/81; 428/42.1

(57) ABSTRACT

An adhesive label is produced by a process that includes the steps of providing a web consisting of an adhesive label substrate having a face material, an adhesive layer and a liner. The web has a web width and a web direction and a plurality of non-adhesive strips positioned between adhesive portions in parallel alignment with the web direction. The web is positioned in a label conversion machine wherein the web is continuously pulled through the conversion machine in a preselected web direction. A plurality of labels are configured on the web wherein a first portion of each label overlays a non-adhesive strip and a second portion of each label overlays an adhesive portion. The labels are cut on the web and printed with indicia used in food safety labeling systems. The labels are then further processed into individual rolled strips for use in food safety labeling systems wherein the back surface of each label has a first non-adhesive portion and a second adhesive portion.

### CROSS-REFERENCE TO RELATED APPLICATIONS

The present application is a division of and claims priority to U.S. patent application Ser. No. 09/938,920, filed Aug. 24, 2001.

### BRIEF SUMMARY OF THE INVENTION

1. Field of the Invention

The present invention relates to adhesive labels and more particularly to a process for making adhesive labels having a non-adhesive portion for use in food safety labeling systems.

2. Background of the Invention

Existing labels range in size and shape, and have specific adhesives and face materials for very specific purposes. For example, food safety is a major concern for restaurants and other establishments involved in the storage and preparation of food for human consumption (the food services industry). To ensure such food safety, the food services industry applies adhesive labels to the surface of containers holding food to inform the food handler as to the types of food and its date of preparation and/or date of possible spoilage or non-use. These labels are used as part of food safety labeling systems and there are numerous variations of food safety labeling systems currently on the market. Presently the label shapes most commonly used in food safety labeling systems are circles, squares, and rectangles.

There are three main types of labels used in these food safety labeling systems—day of the week FIFO (first in first out) systems, shelf-life/product identification labels and use by/use first labeling. Food safety labeling systems also use an industry standard color code system of blue for Monday, yellow for Tuesday, red for Wednesday, brown for Thursday, green for Friday, orange for Saturday, and black for Sunday on the labels. These colors are used to quickly identify the days of the week on labels used in food safety labeling systems.

It is customary practice to replace the adhesive label with a new label once the food is used and the container is cleaned. To remove the label, an individual normally removes the label by hand or by using a high temperature washing. There are adhesive labels that are known to dissolve when subjected to such high temperature conditions, such as in a high temperature dishwasher. If such a dissolvable label is not used, however, the adhesive layer holding a conventional label to the surface frequently is difficult to separate from the surface of the food container in order to remove the label from the container. This is especially true after the container has been washed the label was begun to deteriorate.

There are three main components used in the production of adhesive or pressure sensitive adhesive labels. The process, commonly referred to as “converting,” requires a pressure sensitive or adhesive substrate, and converting machinery that includes a cutting die or other cutting means. An additional aspect of adhesive or pressure sensitive label converting is printing on the formed label. This is done using printing inks and plates during the converting process.

A pressure sensitive or adhesive substrate is a construction of three elements: face material, adhesive, and liner. The substrate is generally produced by and purchased from a specialty supplier of adhesive materials. The face material is the visible part of the label. It is the top layer in the construction of the substrate and is the surface to which the printing ink is applied. The face material is most commonly paper, but can also be polyester, vinyl, polypropylene or even foil. The type of face material selected for a label is determined by the intended use of the label and the desired quality of the printing. The adhesive is the part of the label that makes it stick and it is coated to the under surface of the face material while the substrate is being produced. There are several types of adhesives applicable for various applications. Examples include permanent, removable, water-soluble, and cold temperature adhesives. The liner is a silicone-coated sheet of paper that allows the face material and applied adhesive to be easily removed for application on other surfaces. The adhesive substrate is usually supplied in rolls and during the converting process, the substrate is referred to as the “web.”

The cutting die is a precision-machined rotary tool that cuts the substrate into shapes. The cutting die is made of steel and has sharpened blades that cut through the face material and adhesive, but does not cut into the liner. The die cuts the substrate as it passes through the cutting die location in the converting machinery. Cutting of the shapes into the substrate can also be performed by lasers.

After the shapes have been cut into the web, the waste area between the labels is pulled away. This waste area is called the “matrix.” Removal of the matrix leaves the individual label shapes on the liner to be wound back into a roll for further processing. Cutting dies and lasers can cut very simple shapes such as circles or squares, or very complex shapes depending on the application. The labels are then processed through the printing press portion of the converting machinery and the rolls of labels are further processed on a rewinder. The blades on the rewinder slit the web into individual strips, which are wound into small rolls of generally 500 to 1000 labels each. The small rolls are then packaged for shipping.

There is a need for a label used in food safety labeling systems that will remain securely adhered to a surface, but is easily removed from that surface without leaving an adhesive residue or other label remnant.

There is also a need for a label for use in food safety labeling systems that includes a non-adhesive portion configured for grasping in order to more easily remove the label from the surface of a container.

### SUMMARY OF THE INVENTION

In accordance with the present invention, an adhesive label is produced by a process that includes the steps of providing a web consisting of an adhesive label substrate having a face material, an adhesive layer and a liner in which the web has a web width and a web direction. The web also includes a plurality of non-adhesive strips positioned between parallel aligned adhesive portions in which the strips and portions are oriented in parallel alignment with the web direction. The web is positioned in a label conversion machine wherein the web is continuously pulled through the conversion machine in a preselected web direction. A plurality of labels is configured on the web wherein a first portion of each label overlays a non-adhesive strip and a second portion of each label overlays an adhesive portion. Each label has front and back surfaces. The plurality of labels are cut on the web and the front surfaces of the labels are printed with indicia used in food safety labeling systems. Thereafter, the labels are processed into individual rolled strips for use in food safety labeling systems in which the first portion of each label is non-adhesive and the second portion of each label is adhesive.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a front plan view of one embodiment of a label produced by the inventive process;

FIG. 2 is a back plan view of the label of FIG. 1;

FIG. 3 is a front plan view of an alternate embodiment of a label produced by the inventive process;

FIG. 4 is a back plan view of the label of FIG. 3;

FIG. 5 is an illustration of the layers of a pressure sensitive substrate used in the subject invention;

FIG. 6 is an illustration of an inventive conversion configuration for the label of FIG. 1;

FIG. 7 is an illustration of a portion of a web with the configuration of FIG. 6;

FIG. 8 is an illustration of an inventive conversion configuration for the label of FIG. 3;

FIG. 9 is an illustration of a portion of a web with the configuration of FIG. 8;

FIG. 10 is an illustration of an inventive conversion configuration for the label of FIGS. 13, 14, and 16-18;

FIG. 11 is an illustration of the label of FIG. 1 for use in a food safety labeling system;

FIG. 12 is an illustration of the label of FIG. 3 for use in a food safety labeling system;

FIG. 13 is a front plan view of an alternate embodiment of a label produced by the inventive process for use in a food safety labeling system;

FIG. 14 a front plan view of an alternate embodiment of a label produced by the inventive process for use in a food safety labeling system;

FIG. 15 is a back plan view of the label of FIG. 14;

FIGS. 16A and 16B are front plan views of alternate embodiments of a label produced by the inventive process for use in a food safety labeling system;

FIG. 17 is a front plan view of alternate embodiments of a label produced by the inventive process for use in a food safety labeling system; and

FIG. 18 is a front plan view of alternate embodiments of a label produced by the inventive process for use in a food safety labeling system.

### DETAILED DESCRIPTION OF THE PREFERRED EMBODIMENTS

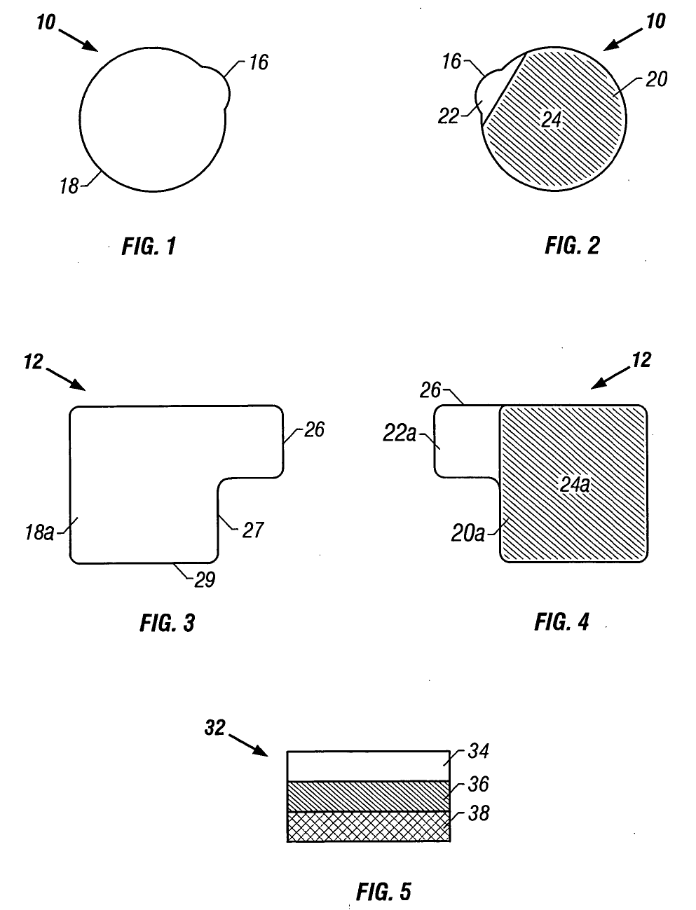

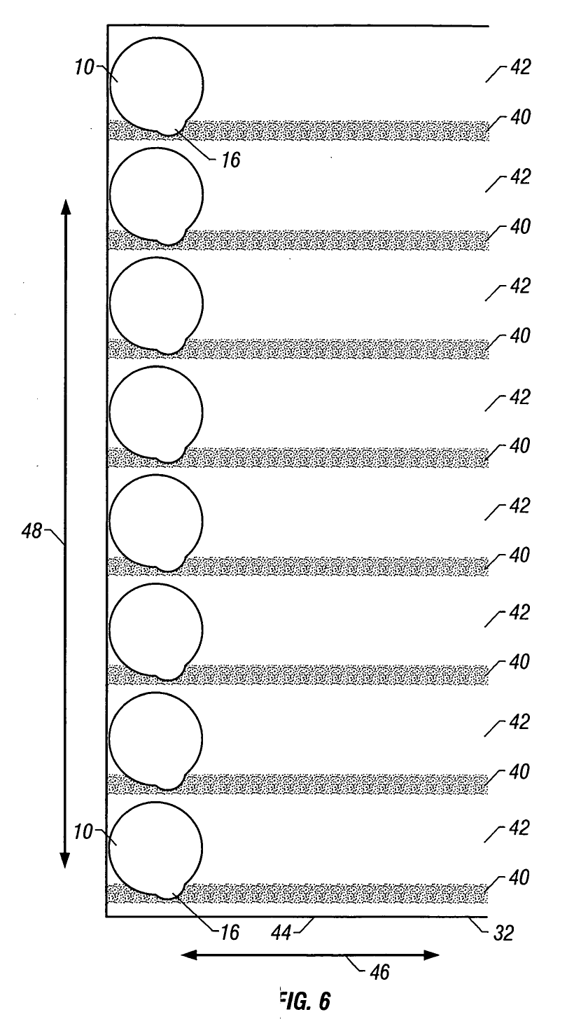

The present invention is directed to a pressure sensitive or adhesive label having a non-adhesive portion and a process for configuring pressure sensitive or adhesive labels having a non-adhesive portion for use in a food safety labeling system. The labels of the present invention can be formed in a number of shapes such as circular, square and rectangular. A circular shaped label 10 is illustrated in FIG. 1, a rectangular shaped label 12 with a tab is illustrated in FIG. 3 and a rectangular or square shaped label 14 is illustrated in FIGS. 13, 14, and 16-18.

The circular shaped label 10 has a slightly protruding tab 16 extending from a portion of the circular label 10. Preferably, tab 16 extends from a position that is generally between a 2:00 o'clock and 3:00 o'clock position on the circular label 10. Label 10 has a front surface 18 and a back surface 20 (FIGS. 1 and 2). In the process of the subject invention, the back surface 20 of label 10 is formed with a non-adhesive portion 22 on tab 16 and an adhesive portion 24 on the remaining back surface 20 of label 10 (FIG. 2).

The rectangular shaped label 12 has a bottom edge 29 and a tab 26 extending from a side 27 of label 12. Label 12 has a front surface 18a and a back surface 20a (FIGS. 3 and 4). The back surface 20a of label 12 is formed with a non-adhesive portion 22a on tab 26 and an adhesive portion 24a on the remaining back surface 20a of label 12 (FIG. 4).

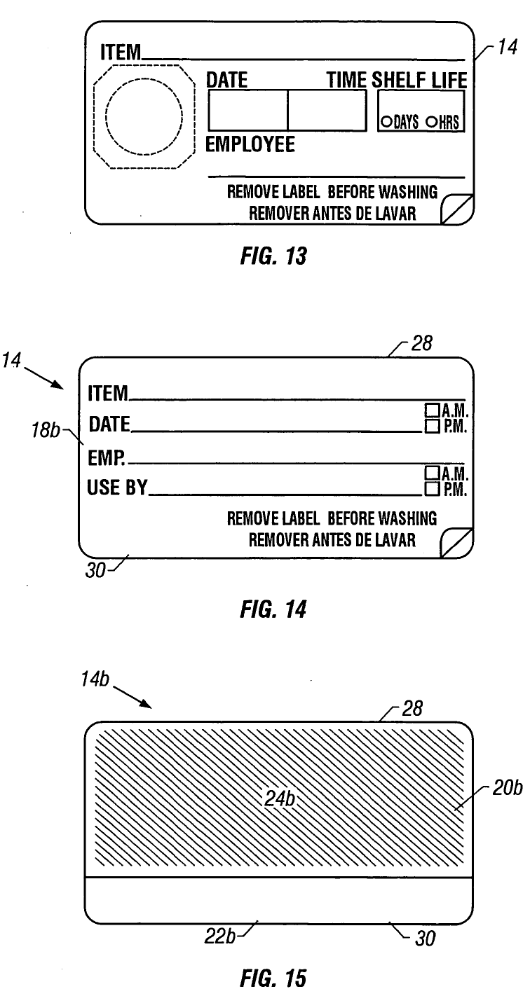

The rectangular or square shaped label 14 has a top edge 28, a bottom edge 30, a front surface 18b and a back surface 20b (FIGS. 14 and 15). The back surface 20b of label 14 is formed with a non-adhesive portion 22b along the bottom edge 30 and an adhesive portion 24b on the remaining back surface 20b of label 14 (FIG. 15).

The non-adhesive tab 16 of label 10, the non-adhesive tab 26 of label 12 and the non-adhesive bottom edge 30 of labels 13, 14 and 16-18 are configured for grasping by a user in order to more easily remove the labels from the surface of food containers when the labels are used in food safety labeling systems.

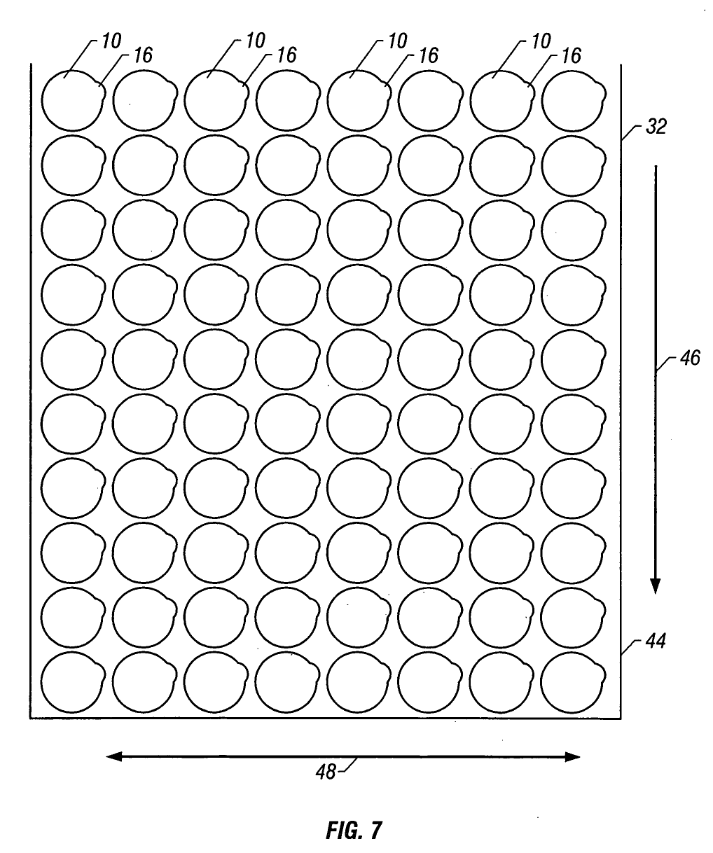

The presently disclosed process utilizes a web 32 which contains a face material 34, an adhesive layer 36, and a liner 38 as shown in FIG. 5. The face material is most commonly paper, but can also be polyester, vinyl, polypropylene or foil. The type of face material selected for a label is determined by the intended use of the label and the desired quality of the printing. There are several types of adhesives applicable for various applications. Examples include permanent, removable, water-soluble, and cold temperature adhesives. The liner is a silicone-coated sheet of paper that allows the face material and applied adhesive to be easily removed from the liner for application to other surfaces. The face material, adhesive and liner products are available from manufactures such as Fasson Roll North America, a division of Avery Dennison, Wasau Coated Products and Green Bay Packaging.

The web 32 is supplied from a specialty supplier of adhesive materials, such as Fasson Roll North America, a division of Avery Dennison, Wasau Coated Products and Green Bay Packaging, and is supplied preferably in rolls having patterned adhesive bands in which non-adhesive strips 40 are positioned between adhesive portions 42, (Matte Litho R423 40#PG, from Fasson Roll North America). The non-adhesive strips 40 and the adhesive portions 42 run the length of a roll (not shown), are in parallel alignment with each other and are oriented parallel to the web direction 48. The non-adhesive strips 40 begin at an outer edge 44 of the web 32 and are spaced across the width of the web 32.

In the conversion process, the web 32 is continuously pulled through the conversion machinery (not shown) in one direction called the web direction 46 which is the direction the web 32 is traveling as it passes through the conversion machinery. The total width of the substrate perpendicular to the web direction 46 is called the web width 48. The cutting of the labels is performed according to the placement of the label shapes on the face material 34 in which rows of labels are formed both across the web width 48 and along the length of the web. The labels are then processed through the printing press portion of the converting machinery in which the front surfaces of the labels are printed and the rolls of labels are further processed on a rewinder. The blades on the rewinder slit the web into individual strips, which are wound into small rolls of generally 500 to 1000 labels each. The small rolls are then packaged for shipping. This conversion process is generally known to one skilled in the art of making labels.

A preferred configuration of label 10 is illustrated in FIGS. 6 and 7. A patterned adhesive web 32, having a web width 48 of generally about 8.79 inches, will accommodate eight labels 10, each having a diameter of 15/16 of an inch, placed horizontally across the web width 48 and parallel to the web width 48. For a configuration of eight labels 10, placed across a web width 48, each having a diameter of 15/16 of an inch, the first non-adhesive strip 40 is positioned on the web 32 generally about 0.16795 inches from the outer edge 44 and each non-adhesive strip 40 is generally about 0.1875 inches wide. Each adhesive portion 42 would be generally about 0.91435 inches wide. In the configuration for eight labels placed across the web width 48, there would be eight parallel non-adhesive strips 40 spaced between eight parallel adhesive portions 42 as illustrated in FIG. 6. Each label 10 is positioned such that tab 16 and a small portion of label 10 overlays a non-adhesive strip 40 and the remainder of label 10 overlays adhesive portion 42. When labels 10 are die cut into the patterned adhesive web 32, the back side 20 of circular label 10 will include an adhesive portion 24 and a non-adhesive portion 22 on back side of tab 16. FIG. 7 illustrates the inventive configuration for multiple rows of label 10. The dimensions and widths discussed above are for illustrative purposes only, as one skilled in the art would recognize that circular labels having different dimensions would require patterned adhesive webs with different dimensions.

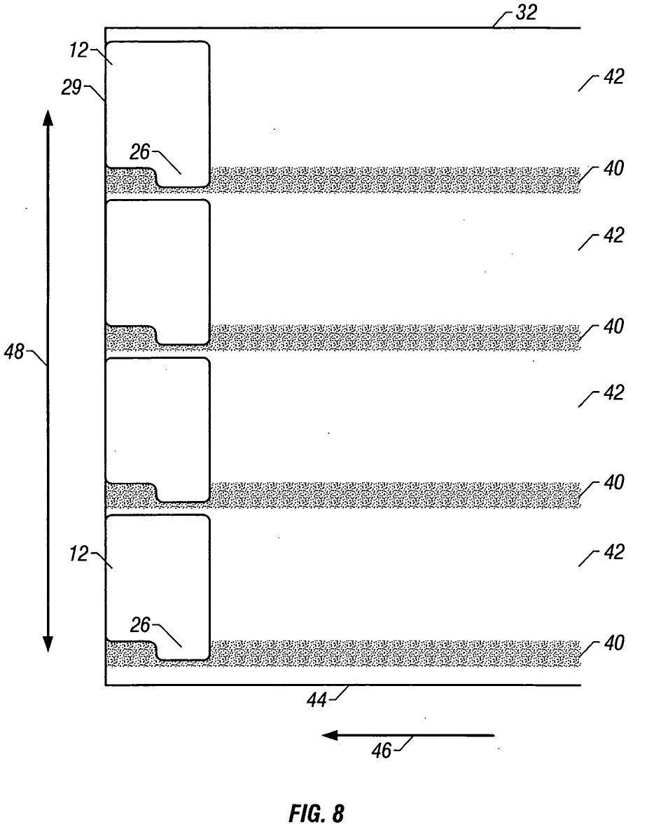

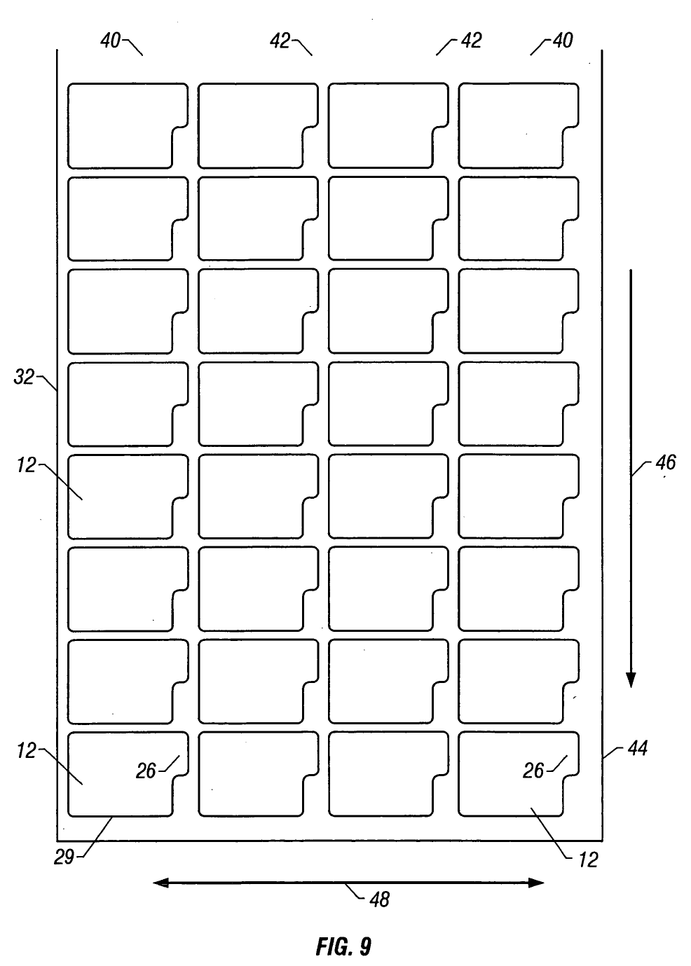

A preferred configuration of label 12 is illustrated in FIGS. 8 and 9. A patterned adhesive web 32, having a web width 48 of generally about 6.5 inches, will accommodate four labels 12, each having a dimension of generally about 15/16 inch high and 1 3/16 inch wide, placed horizontally across the web width 48, with the bottom edge 29 of label 12 parallel to the web width 48. For a configuration of four labels 12, placed across a web width 48, each having a dimension of 15/16×1 3/16 of an inch, the first non-adhesive strip 40 is positioned on the web 32 generally about 0.1875 inches from the outer edge 44 and each non-adhesive strip 40 is generally about 0.25 inches wide. Each adhesive portion 42 would be generally about 1.3125 to 1.375 inches wide. In the configuration for four labels placed across the web width 48, there would be four parallel non-adhesive strips 40 spaced between four parallel adhesive portions 42 as illustrated in FIG. 8. Each label 12 is positioned such that tab 26 overlays a non-adhesive strip 40 and the remainder of label 12 overlays adhesive portion 42. When labels 12 are die cut into the patterned adhesive web 32, the back side 20a of label 12 will include an adhesive portion 24a and a non-adhesive portion 22a on the back side of tab 26. FIG. 9 illustrates the inventive configuration for multiple rows of label 12. The dimensions and widths discussed above are for illustrative purposes only, as one skilled in the art would recognize that tabbed rectangular or square labels having different dimensions would require patterned adhesive webs with different dimensions.

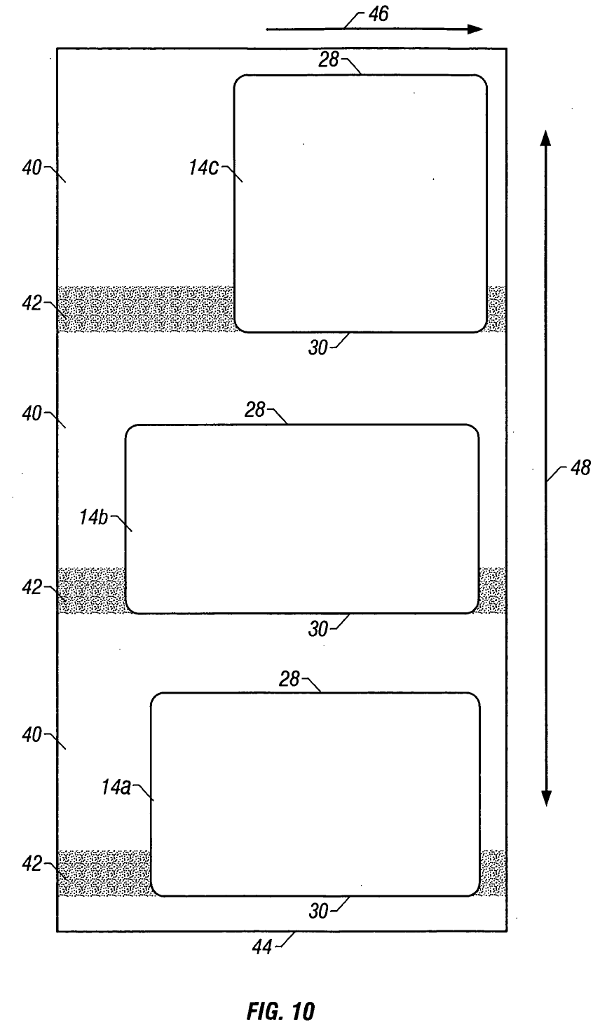

A preferred configuration of label 14 is illustrated in FIG. 10. A patterned adhesive web 32, having a web width 48 of generally about 10.0 inches, will accommodate three rectangular or square shaped labels 14, having various dimensions such as: 3⅞ inches wide by 1 15/16 inches high (label 14a); 4⅛ inches wide by 2 inches high (label 14b); and 3 inches by 3 inches (label 14c). Labels 14 are placed horizontally across the web width 48, with the bottom edge 30 of labels 14 being perpendicular to the web width 48. For a configuration of three rectangular or square shaped labels 14, placed across the web width 48, having dimensions generally within the range described above, the first non-adhesive strip 40 is positioned on the web 32 generally about 0.4375 inches from outer edge 44 and each non-adhesive strip 40 is generally about 0.5625 inches wide. Each adhesive portion 42 would be generally about 2.5625 to 2.75 inches wide. In the configuration for three labels placed across the web width 48, there would be three parallel non-adhesive strips 40 spaced between three parallel adhesive portions 42 as illustrated in FIG. 10. Each label 14 is positioned such that bottom edge 30 overlays a non-adhesive strip 40 and the remainder of label 14 overlays adhesive portion 42. When labels 14 are die cut into the patterned adhesive web 32, the back side 20b of label 14 will include an adhesive portion 24b and a non-adhesive portion 22b. The adhesive portion 22b is oriented along and parallel to the bottom edge 30 of each label 14. The width of the non-adhesive portion 22b will be the width of the non-adhesive strip 42. The dimensions and widths discussed above are for illustrative purposes only, as one skilled in the art would recognize that rectangular or square labels having different dimensions would require patterned adhesive webs with different dimensions.

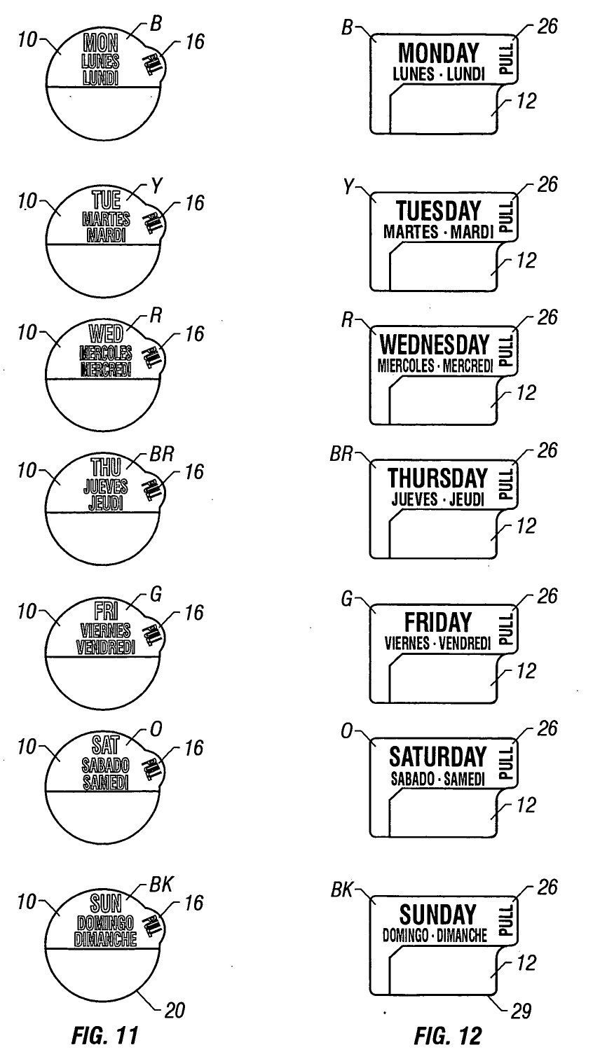

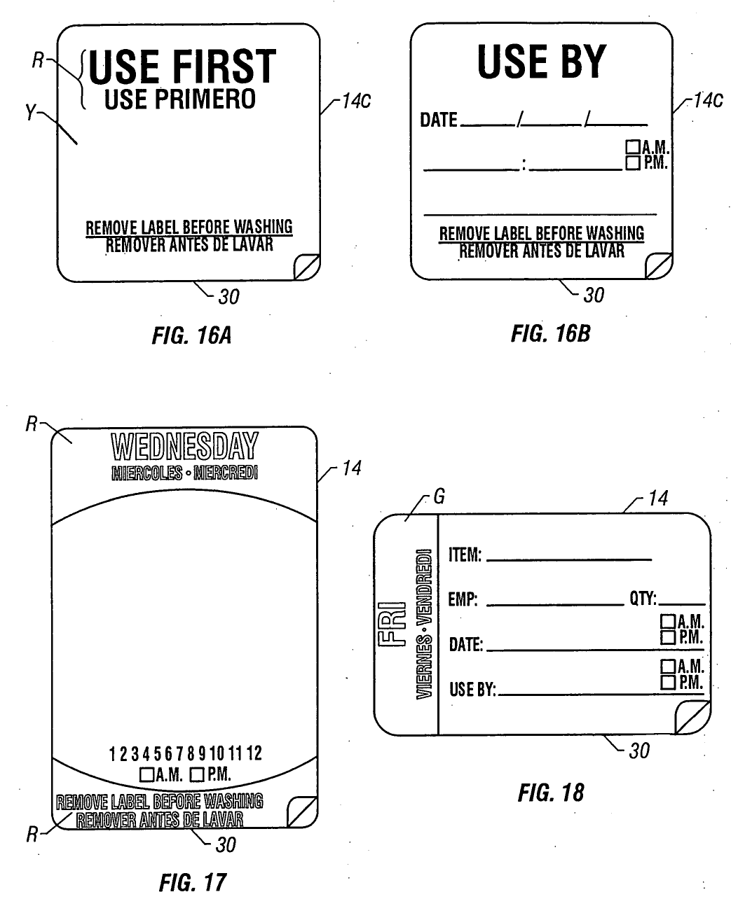

The inventive labels 10, 12 and 14 can be made to conform to the three main types of labels used in food safety labeling systems—day of the week FIFO (first in first out) systems, shelf-life/product identification labels and use by/use first labeling. The inventive labels 10, 12 and 14 can include the established food safety color code system in which the color blue B is for Monday, yellow Y for Tuesday, red R for Wednesday, brown BR for Thursday, green G for Friday, orange O for Saturday, and black BK for Sunday (FIGS. 11, 12, 17 and 18). Alternatively, as illustrated in FIG. 16A, labels 14 can also be in colors such as yellow (Y) and can include colored text such as red (R). The labels 10, 12 and 14 can also include day-of-the-week text as well as other food rotation text as illustrated in FIGS. 11-14 and 16-18. Preferably, the text will be multilingual to include any combinations of English, Spanish, French, Italian or German. Additionally, the inventive labels 10, 12 and 14 will utilize face materials and adhesives specifically designed for food rotation and FIFO labeling in the food services industry.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A process for forming an adhesive label having a non-adhesive portion comprising the steps of: providing a web consisting of an adhesive label substrate having a face material, an adhesive layer and a liner, the web having a web width and a web direction, and a plurality of non-adhesive strips positioned between parallel aligned adhesive portions, the strips and portions being oriented in parallel alignment with the web direction; positioning the web in a label conversion machine wherein the web is continuously pulled through the conversion machine in a preselected web direction; configuring a plurality of labels on the web wherein a first portion of each label overlays a non-adhesive strip and a second portion of each label overlays an adhesive portion, each label having a front surface and a back surface; cutting the plurality of labels on the web; printing the front surface of the plurality of labels with indicia used in food safety labeling systems; and processing the plurality of labels into individual rolled strips for use in food safety labeling systems, wherein the back surface of each label has a first non-adhesive portion and a second adhesive portion.

2. The process of claim 1, wherein the labels are formed in shapes selected from a group of label shapes consisting of a circular label with a protruding tab, a square label with a tab extending from a side portion, a rectangular label with a tab extending from a side portion, a square label, and a rectangular label.

3. The process of claim 2, wherein the first non-adhesive portion of the circular label with a protruding tab is the back surface of the tab and the second adhesive portion is the remaining back surface of the circular label

4. The process of claim 2, wherein the first non-adhesive portion of the square or rectangular label with an extending tab is the back surface of the tab and the second adhesive portion is the remaining back surface of the square or rectangular label.

5. The process of claim 2, wherein the square and rectangular label each have a top edge and a bottom edge.

6. The process of claim 5, wherein the first non-adhesive portion of the square or rectangular label is a portion of the back surface of each label that is oriented along and parallel to the bottom edge of each label and the second adhesive portion is the remaining back surface of the square or rectangular label.

7. The process of claim 1, wherein the non-adhesive portion is configured for grasping by a user in order to remove the label from a surface of a container.

8. The process of claim 1, wherein the configuration for a row of circular labels having a protruding tab is eight labels placed horizontally across the web width and parallel to the web width.

9. The process of claim 8, wherein the configuration further includes eight non-adhesive strips positioned between eight adhesive portions.

10. The process of claim 1, wherein the configuration for a row of square or rectangular labels, each having a bottom edge and a tab extending from a side of each label, is four labels placed horizontally across the web width with the bottom edge of each label parallel to the web width.

11. The process of claim 10, wherein the configuration further includes four non-adhesive strips and four adhesive portions.

12. The process of claim 1, wherein the configuration for a row of square or rectangular labels each having a bottom edge is at least three labels placed horizontally across the web width with the bottom edge of each label perpendicular to the web width.

13. The process of claim 12, wherein the configuration further includes three non-adhesive strips and three adhesive portions.

14. The process of claim 1, wherein the web width is generally between 6.5 to 10 inches.

15. The process of claim 1, wherein the face material is selected from a group consisting of paper, polyester, vinyl, polypropylene and foil.

16. The process of claim 1, wherein the adhesive layer is formed from an adhesive selected from a group consisting of permanent, removable, water-soluble, and cold temperature adhesives.

17. The process of claim 1, wherein the liner is a silicone-coated sheet of paper adapted to allow the face material and adhesive layer to be easily removed.

18. The process of claim 1, further including the step of removing a matrix of waste material between the plurality of labels after cutting the plurality of labels on the web.

19. The process of claim 1, wherein the indicia used in food safety labeling systems includes text selected from a group consisting of text found in day of the week FIFO food safety labeling systems, text relating to shelf-life/product identification food safety labeling systems and text relating to use by/use first food safety labeling systems.

20. The process of claim 1, wherein the indicia used in food safety labeling systems includes color related to an industry standard color code system used in food safety labeling systems.

21. The process of claim 20, wherein the color used includes an industry standard color code system selected from a group of colors consisting of blue for Monday, yellow for Tuesday, red for Wednesday, brown for Thursday, green for Friday, orange for Saturday, and black for Sunday.

22. (Canceled)

23. (Canceled)

24. (Canceled)

25. (Canceled)

26. (Canceled)

27. (Canceled)

28. (Canceled)

29. The adhesive label of claim 22, wherein the configuration for a row of circular labels having a protruding tab is eight labels placed horizontally across the web width and parallel to the web width.

30. The adhesive label of claim 22, wherein the configuration for a row of square or rectangular labels, each having a bottom edge and a tab extending from a side of each label, is four labels placed horizontally across the web width with the bottom edge of each label parallel to the web width.

31. The adhesive label of claim 22, wherein the configuration for a row of square or rectangular labels each having a bottom edge is at least three labels placed horizontally across the web width with the bottom edge of each label perpendicular to the web width.

32. The adhesive label of claim 22, wherein the face material is selected from a group consisting of paper, polyester, vinyl, polypropylene and foil.

33. The adhesive label of claim 22, wherein the adhesive layer is formed from an adhesive selected from a group consisting of permanent, removable, water-soluble, and cold temperature adhesives.

34. The adhesive label of claim 22, wherein the liner is a silicone-coated sheet of paper adapted to allow the face material and adhesive layer to be easily removed.

35. The adhesive label of claim 22, further including the step of removing a matrix of waste material between the plurality of labels after cutting the plurality of labels on the web.

36. The adhesive label of claim 22, wherein the indicia used in food safety labeling systems includes text selected from a group consisting of text found in day of the week FIFO food safety labeling systems, text relating to shelf-life/product identification food safety labeling systems and text relating to use by/use first food safety labeling systems.

37. The adhesive label of claim 22, wherein the indicia used in food safety labeling systems includes color related to an industry standard color code system used in food safety labeling systems.

38. The adhesive label of claim 37, wherein the color used includes an industry standard color code system selected from a group of colors consisting of blue for Monday, yellow for Tuesday, red for Wednesday, brown for Thursday, green for Friday, orange for Saturday, and black for Sunday.

39. A process for forming an adhesive label having a non-adhesive portion comprising the steps of: providing a web consisting of an adhesive label substrate having a face material, an adhesive layer and a liner, the web having a web width and a web direction, and a plurality of non-adhesive strips positioned between parallel aligned adhesive portions, the strips and portions being oriented in parallel alignment with the web direction; positioning the web in a label conversion machine wherein the web is continuously pulled through the conversion machine in a preselected web direction; configuring a plurality of labels on the web wherein a first portion of each label overlays a non-adhesive strip and a second portion of each label overlays an adhesive portion, each label having a front surface and a back surface; cutting the plurality of labels on the web; printing the front surface of the plurality of labels with text selected from a group consisting of text found in day of the week FIFO food safety labeling systems, text relating to shelf-life/product identification food safety labeling systems and text relating to use by/use first food safety labeling systems used in food safety labeling systems and an industry standard color code system selected from a group of colors consisting of blue for Monday, yellow for Tuesday, red for Wednesday, brown for Thursday, green for Friday, orange for Saturday, and black for Sunday; and processing the plurality of labels into individual rolled strips for use in food safety labeling systems, wherein the back surface of each label has a first non-adhesive portion and a second adhesive portion.
